(19) United States
(12) Patent Application Publication
(10) Pub. No.: US 2026/0289750 A1
(43) Pub. Date: Sep. 24, 2026

(54) METHOD, APPARATUS, DEVICE AND STORAGE MEDIUM FOR GENERATING MEDIA CONTENT

(71) Applicants: Beijing Zitiao Network Technology Co., Ltd., Beijing (CN); Peking University, Beijing (CN)

(72) Inventors: Xin Xia, Beijing (CN); Ye Tian, Beijing (CN); Xuefeng Xiao, Beijing (CN); Bin Cui, Beijing (CN)

(21) Appl. No.: 19/574,194

(22) Filed: Mar. 20, 2026

(30) Foreign Application Priority Data
Mar. 24, 2025 (CN) 202510353440.3

(51) Int. Cl. G06T 5/70; G06N 3/0475; G06T 3/40

(52) U.S. Cl. CPC G06T 5/70; G06N 3/0475; G06T 3/40; G06T 2207/20182

(57) ABSTRACT

According to embodiments of the disclosure, a method, an apparatus, a device, and a storage medium for generating media content are provided. The method includes: receiving a media generation request associated with a diffusion model; and generating media content for the media generation request based on a denoising process of the diffusion model, the denoising process including at least a first stage, a second stage, and a third stage, the first stage being configured to perform at least one round of denoising on first noise data to determine a first feature representation, the second stage being configured to perform at least one round of denoising on second noise data to determine a second feature representation, the second noise data being constructed based on down-sampling the first feature representation, and the third stage being configured to perform at least one round of denoising on third noise data.

### CROSS-REFERENCE

The present application claims the priority of Chinese Patent Application No. 202510353440.3, filed on Mar. 24, 2025, and entitled “Method, Apparatus, Device and Storage Medium for Generating Media Content”, which is hereby incorporated by reference in its entirety.

### FIELD

Example embodiments of the present disclosure generally relate to the field of computers, and in particular, to a method, an apparatus, a device, and a computer-readable storage medium for generating media content.

### BACKGROUND

A diffusion model is a type of content generation model that generates new samples by simulating a process of data gradually transforming from noise to a target distribution. A core idea of the diffusion model is to transform a data distribution into a simple distribution by gradually adding noise, and then restore data from the noise through a reverse process. However, because the diffusion model may theoretically approximate a complex data distribution, and the generated content often has higher quality and consistency, the diffusion model also requires a high computing cost, resulting in low content generation efficiency.

### SUMMARY

In a first aspect of the present disclosure, a method of generating media content is provided. The method includes: receiving a media generation request associated with a diffusion model; and generating media content for the media generation request based on a denoising process of the diffusion model, the denoising process including at least a first stage, a second stage, and a third stage, the first stage being configured to perform at least one round of denoising on first noise data to determine a first feature representation, the second stage being configured to perform at least one round of denoising on second noise data to determine a second feature representation, the second noise data being constructed based on down-sampling the first feature representation, and the third stage being configured to perform at least one round of denoising on third noise data, the third noise data being constructed based on up-sampling the second feature representation.

In a second aspect of the present disclosure, an apparatus for generating media content is provided. The apparatus includes: a receiving module configured to receive a media generation request associated with a diffusion model; and a generating module configured to generate media content for the media generation request based on a denoising process of the diffusion model, the denoising process including at least a first stage, a second stage, and a third stage, the first stage being configured to perform at least one round of denoising on first noise data to determine a first feature representation, the second stage being configured to perform at least one round of denoising on second noise data to determine a second feature representation, the second noise data being constructed based on down-sampling the first feature representation, and the third stage being configured to perform at least one round of denoising on third noise data, the third noise data being constructed based on up-sampling the second feature representation.

In a third aspect of the present disclosure, an electronic device is provided. The device includes at least one processor; and at least one memory, the at least one memory being coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The computer-readable storage medium stores a computer program executable by a processor to implement the method of the first aspect.

In a fifth aspect of the present disclosure, a computer program product is provided. The computer program product includes computer-executable instructions that, when executed by a processor, implement the method of the first aspect.

It should be understood that content described in this Summary section is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which the embodiments of the present disclosure may be implemented;

FIG. 2 illustrates a flowchart of a process of generating media content according to some embodiments of the present disclosure;

FIG. 3 illustrates a flowchart of a denoising process according to some embodiments of the present disclosure;

FIG. 4 illustrates a schematic structural block diagram of an apparatus for generating media content according to some embodiments of the present disclosure; and

FIG. 5 illustrates a block diagram of an electronic device capable of implementing a plurality of embodiments of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for illustrative purposes and are not intended to limit the protection scope of the present disclosure.

It should be noted that any section/subsection titles provided herein are not restrictive. Various embodiments are described throughout this article, and any type of embodiment may be included in any section/subsection. In addition, the embodiments described in any section/subsection may be combined with any other embodiments described in the same section/subsection and/or different section/subsection in any manner.

In the description of the embodiments of the present disclosure, the term “include/comprise” and like terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may be included below. The terms “first”, “second”, and the like may refer to different or same objects. Other explicit and implicit definitions may be included below.

The embodiments of the present disclosure may involve user data, data acquisition, and/or data use. These aspects all comply with corresponding laws, regulations, and related provisions. In the embodiments of the present disclosure, all data collection, acquisition, processing, machining, forwarding, use, and the like are performed on the premise that the user is aware of and confirms. Correspondingly, when implementing the embodiments of the present disclosure, the user should be informed of the type, range of use, use scenarios, etc., of data or information that may be involved and the authorization of the user should be obtained in an appropriate manner in accordance with relevant laws and regulations. A specific manner of informing and/or authorizing may vary according to the actual situation and application scenarios, and the scope of the present disclosure is not limited in this regard.

If the solutions in this specification and the embodiments involve personal information processing, the processing is performed on the premise that there is a legal basis (for example, the consent of the personal information subject is obtained, or it is necessary to perform a contract, etc.), and the processing is only performed within the scope of the provisions or agreements. If the user refuses to process personal information other than the necessary information required for the basic functions, it will not affect the user's use of the basic functions.

Traditionally, a diffusion model is a type of content generation model that generates new samples by simulating a process of data gradually transforming from noise to a target distribution. A core idea of the diffusion model is to transform a data distribution into a simple distribution by gradually adding noise, and then restore data from the noise through a reverse process. However, the current efficiency of media content generation is relatively low.

The embodiments of the present disclosure provide a solution to generate media content. According to the solution, a media generation request associated with a diffusion model is received; and media content for the media generation request is generated based on a denoising process of the diffusion model, the denoising process including at least a first stage, a second stage, and a third stage, the first stage being configured to perform at least one round of denoising on first noise data to determine a first feature representation, the second stage being configured to perform at least one round of denoising on second noise data to determine a second feature representation, the second noise data being constructed based on down-sampling the first feature representation, and the third stage being configured to perform at least one round of denoising on third noise data, the third noise data being constructed based on up-sampling the second feature representation. Because data dimension and calculation amount may be reduced by the down-sampling operation, the efficiency of media content generation may be improved by performing denoising processing on the second noise data after down-sampling.

### Example Environment

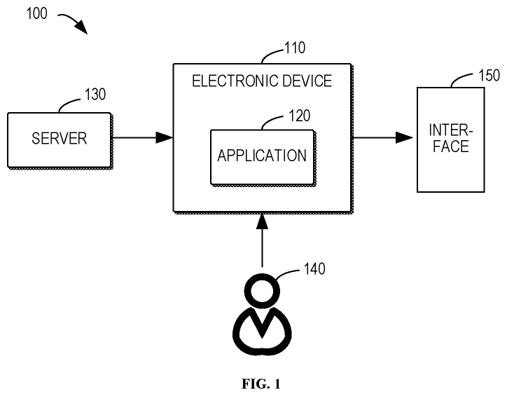

FIG. 1 illustrates a schematic diagram of an example environment 100 in which the embodiments of the present disclosure may be implemented. As shown in FIG. 1, the example environment 100 may include an electronic device 110.

In some embodiments, the electronic device 110 may receive a media generation request associated with a diffusion model 120; and generate media content for the media generation request based on a denoising process of the diffusion model 120, the denoising process including at least a first stage, a second stage, and a third stage, the first stage being configured to perform at least one round of denoising on first noise data to determine a first feature representation, the second stage being configured to perform at least one round of denoising on second noise data to determine a second feature representation, the second noise data being constructed based on down-sampling the first feature representation, and the third stage being configured to perform at least one round of denoising on third noise data, the third noise data being constructed based on up-sampling the second feature representation. The diffusion model 120 may be deployed on the electronic device 110 or on other device(s), which will not be described in detail herein.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices or any combination thereof. In some embodiments, the electronic device 110 may also support any type of interface for a target user (such as “wearable” circuitry, etc.).

The electronic device 110 may also be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The electronic device 110 may include, for example, a computing system/server, such as a mainframe, an edge computing node, a computing device in a cloud environment, and so on.

It should be understood that the structures and functions of the elements in the environment 100 are described for illustrative purposes only, without suggesting any limitation to the scope of the present disclosure.

Some example embodiments of the present disclosure are described below with continued reference to the drawings.

### Example Process

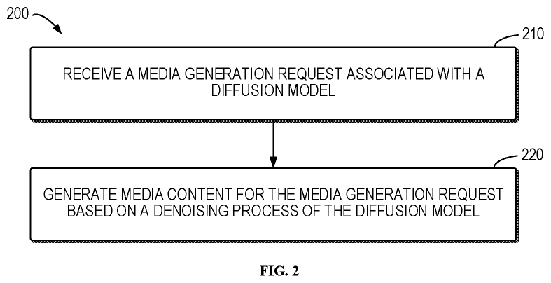

FIG. 2 illustrates a flowchart of a process 200 of generating media content according to some embodiments of the present disclosure. The process 200 may be implemented at the electronic device 110. The process 200 is described below with reference to FIG. 1.

At block 210, the electronic device 110 receives a media generation request associated with a diffusion model.

In some embodiments, the media generation request is a request provided to a network model to guide a content generation process of the network model. The media generation request may include a request for generating image content or a request for generating video content. For example, the media generation request may be “generate a cartoon-style image”. For another example, the media generation request may further indicate reference information, such as a reference image.

At block 220, the electronic device 110 generates media content for the media generation request based on a denoising process of the diffusion model.

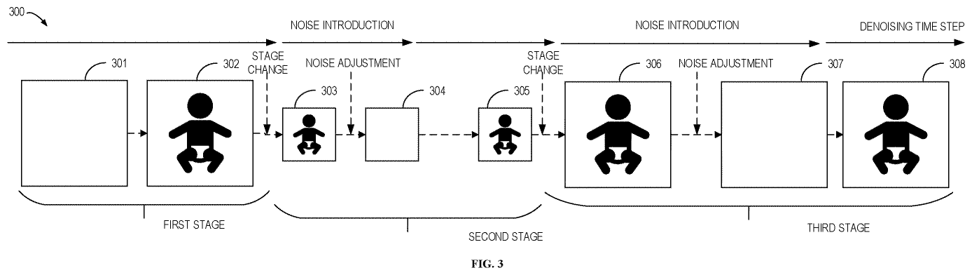

In some embodiments, the diffusion model is a type of content generation model that generates new samples by simulating a process of data gradually transforming from noise to a target distribution. A core idea of the diffusion model is to transform a data distribution into a simple distribution by gradually adding noise, and then restore data from the noise through a reverse process. In the embodiments of the present disclosure, referring to FIG. 3, the diffusion model may perform a step-by-step denoising operation according to the media generation request, and finally generate media content 308.

In some embodiments, referring to FIG. 3, the denoising process may include multiple stages, each stage corresponds to a corresponding resolution, and the electronic device 110 may set the denoising process to include at least a first stage, a second stage, and a third stage. The first stage is configured to perform at least one round of denoising on first noise data 301 to determine a first feature representation 302; the second stage is configured to perform at least one round of denoising on second noise data 304 to determine a second feature representation 305, the second noise data 304 being constructed based on down-sampling the first feature representation 302; and the third stage is configured to perform at least one round of denoising on third noise data 307, the third noise data 307 being constructed based on up-sampling the second feature representation 305.

Because a down-sampling operation is performed on the first feature representation 302 in the first stage, the resolution processed in the second stage is lower than that in the first stage. Because an up-sampling operation is performed on the second feature representation 305 in the second stage, the resolution processed in the third stage is higher than that in the second stage. For example, the first stage corresponds to a resolution of 1024, the second stage corresponds to a resolution of 512, and the third stage corresponds to a resolution of 1024. In this way, the diffusion model performs denoising step by step in multiple stages, which may implement efficient inference while ensuring quality.

In some embodiments, the electronic device 110 may determine a preset velocity field corresponding to the diffusion model, the preset velocity field indicating a feature of a next denoising time step generated after denoising processing is performed on a feature of a current denoising time step. Then, denoising processing is performed on the first noise data 301 based on the preset velocity field to generate the media content for the media generation request.

For example, a size of the media content to be generated is h×w, where h represents a height and w represents a width. Then, the first noise data 301 may be represented as x₀∈R^{b×c×h×w}, where b represents a batch size and c represents a number of channels. The denoising process includes K stages, and h₁>h₂> . . . >h_{K-1}<h_{K} and w₁>w₂> . . . >w_{K-1}<w_{K} are satisfied in these stages. If the denoising process includes three stages, h₁>h₂<h₃ and w₁>w₂<w₃ are satisfied.

In addition, the number of inference steps included in each stage may be defined as N₁, N₂, . . . , N_{K}, and then the sum of inferences is

$$T = {\sum }_{i = 1}^{K} {T}_{i} .$$

In each stage i, a discretized denoising time step

$${\{ {t}_{i , j} \}}_{i = 0}^{K} , j = 0 , 1 , … , {N}_{i}$$

may be constructed, and the denoising process may be as follows:

$${X}_{{t}_{i , j}} = {X}_{{t}_{i , j - 1}} + {u}_{θ} ( {X}_{{t}_{i , j - 1}} , y , {t}_{i , j - 1} ) \cdot ( {t}_{i , j} - {t}_{i , j - 1} )$$

u_{θ} represents a preset velocity field, y represents a feature representation corresponding to the media generation request, and j∈{0,1, . . . , Nᵢ}.

In some embodiments, referring to FIG. 3, the electronic device 110 may configure the first stage to perform at least one round of denoising on the first noise data 301 to determine the first feature representation 302. Because semantic information and specific details are difficult to obtain at a low resolution, and the first stage performs inference at a high resolution, performing inference at the high resolution may facilitate the network model to capture the semantic information of the input media content.

In some embodiments, referring to FIG. 3, the electronic device 110 configures the second stage to perform at least one round of denoising on the second noise data 304 to determine the second feature representation 305. Because the second stage targets a feature representation with a relatively low resolution, performing inference at the low resolution in the denoising process may reduce the calculation overhead, and therefore the denoising efficiency of the diffusion model may be improved in this way.

In some embodiments, a method of introducing preset noise into a resolution transition is used to enable a brand-new denoising process from high noise to low noise to be performed at a new resolution, thereby ensuring a more coherent and effective diffusion process. Therefore, the electronic device 110 may determine a third feature representation 303 by down-sampling the first feature representation 302, and then add first random noise to the third feature representation 303 to construct the second noise data 304. Down-sampling is a media content generation technology used to reduce the sampling rate or resolution of data. The down-sampling operation may reduce the amount of data and the computational complexity while retaining the main features of the data.

For example, a formula for performing a down-sampling operation on the first feature representation 302 to obtain the third feature representation 303 may be as follows:

$${X}_{{t}_{i , 0}} = Down ( {X}_{{t}_{i - 1 ,} {N}_{i - 1}} , {h}_{i} , {w}_{i} ) , if {h}_{i} < {h}_{i - 1}$$

i represents a stage, and Xₜ_{_{i_1}}_{,N}_{ᵢ₋₁} represents a final latent representation of a (i−1)th stage, on which a down-sampling operation is performed to match the resolution used in the ith stage. After the resolution is adjusted, the first random noise may be added to the third feature representation 303 to construct the second noise data 304.

In some embodiments, the second stage corresponds to a first number of inference steps, and the first number is determined based on a first weight of the first random noise. The first number is positively correlated with the first weight. For example,

$${\{ {w}_{i} \}}_{i = 0}^{n}$$

may be applied to represent the weight of the noise, and then formulas corresponding to a target time step τᵢ of noise injection and a noise addition process may be as follows:

$${τ}_{i} = {t}_{i , {N}_{i} ( 1 - {w}_{i} )}$$

$${\tilde{X}}_{{t}_{i , 0}} = ( 1 - {τ}_{i} ) {X}_{{t}_{i , 0}} + {τ}_{i} η , η ∼ N ( 0 , I )$$

That is, noise is added to the latent representation of the previous stage, and only the first number Nᵢwᵢ of inference steps are required in the subsequent stage, instead of the complete wᵢ inference steps.

Through a method of introducing preset noise into an intermediate latent representation and performing a brand-new denoising process from high noise to low noise at a new resolution, on the one hand, a training distribution learned by the network model in a training stage may be consistent with an inference distribution faced by the network model in an inference stage, thereby avoiding a mismatch caused by directly transmitting information or features between different resolution stages; on the other hand, a multi-resolution prior of the network model may be applied.

In some embodiments, adjusting the resolution not only changes the spatial features of the data, but also directly affects the signal-to-noise ratio in the latent variable region, thereby weakening the effective signal retained in the previous step. In addition, noise is re-introduced during the resolution adjustment process, and each latent representation essentially returns to a state of a low signal-to-noise ratio. To reduce this impact, an additional scheduler offset may be introduced during the resolution adjustment, thereby achieving a more stable denoising effect.

Therefore, the electronic device 110 may construct a first sampling scheduler corresponding to the second stage based on a first offset coefficient corresponding to the second stage. Then, multiple denoising time steps corresponding to the first number of inference steps are determined based on the first sampling scheduler. Then, at least one round of denoising is performed on the second noise data 304 based on the multiple denoising time steps. For example, the offset coefficient may be represented as

$${\{ s \}}_{i = 0}^{n} ,$$

and an adjustment process of the denoising time step may be as follows:

$${t}_{i , m} = \frac{{s}_{i} \cdot {t}_{i , n}}{1 + ( {s}_{i} - 1 ) {t}_{i , n}}$$

t_{i,n} represents an initial denoising time step, and t_{i,m} represents an adjusted denoising time step. In this way, it may be ensured that the denoising process is consistent with the signal-to-noise ratio that changes under different resolutions, thereby improving the performance of the diffusion model in both image and video generation.

In some embodiments, the electronic device 110 may determine a fourth feature representation 306 by up-sampling the second feature representation 305, and then add second random noise to the fourth feature representation 306 to construct the third noise data 307. Up-sampling is a media content generation technology used to increase the sampling rate or resolution of data. Up-sampling is to insert new data points between original data to achieve data expansion, so that the image may maintain a good visual effect when enlarged, avoiding obvious pixelation or distortion.

For example, a formula for performing an up-sampling operation on the second feature representation 305 to obtain the fourth feature representation 306 may be as follows:

$${X}_{{t}_{i , 0}} = UP ( {X}_{{t}_{i - 1 ,} {N}_{i - 1}} , {h}_{i} , {w}_{i} ) , if {h}_{i} > {h}_{i - 1}$$

i represents a stage, and Xₜ_{ᵢ₋₁}_{,N}_{ᵢ₋₁} represents a final latent representation of a (i−1)th stage, on which an up-sampling operation is performed to match the resolution used in the ith stage. After the resolution is adjusted, the second random noise may be added to the fourth feature representation 306 to construct the third noise data 307.

In some embodiments, the third stage corresponds to a second number of inference steps, and the second number is determined based on a second weight of the second random noise. The second number is positively correlated with the second weight. For example,

$${\{ {w}_{i} \}}_{i = 0}^{n}$$

may be applied to represent the weight of the noise, and then formulas corresponding to a target time step τᵢ of noise injection and the noise addition process may be as follows:

$${τ}_{i} = {t}_{i , {N}_{i} ( 1 - {w}_{i} )}$$

$${\tilde{X}}_{{t}_{i , 0}} = ( 1 - {τ}_{i} ) {X}_{{t}_{i , 0}} + {τ}_{i} η , η ∼ N ( 0 , I )$$

That is, noise is added to the latent representation of the previous stage, and only the second number Nᵢwᵢ of inference steps are required in the subsequent stage, instead of the complete wᵢ inference steps.

In some embodiments, the electronic device 110 may construct a second sampling scheduler corresponding to the third stage based on a second offset coefficient corresponding to the third stage. Then, multiple denoising time steps corresponding to the second number of inference steps are determined based on the second sampling scheduler. Then, at least one round of denoising is performed on the third noise data 307 based on the multiple denoising time steps. For example, the offset coefficient may be represented as

$${\{ s \}}_{i = 0}^{n} ,$$

and the adjustment process of the denoising time step may be as follows:

$${t}_{i , m} = \frac{{s}_{i} \cdot {t}_{i , n}}{1 + ( {s}_{i} - 1 ) {t}_{i , n}}$$

t_{i,n} represents an initial denoising time step, and t_{i,m} represents an adjusted denoising time step. In this way, it may be ensured that the denoising process is consistent with the signal-to-noise ratio that changes under different resolutions, thereby improving the performance of the diffusion model in both image and video generation.

In some embodiments, the denoising process may further include a fourth stage and a fifth stage. The fourth stage is configured to perform at least one round of denoising on fourth noise data to determine a fifth feature representation, and the first noise data 301 is constructed based on down-sampling the fifth feature representation. The fifth stage is configured to perform at least one round of denoising on fifth noise data, the fifth noise data being constructed based on up-sampling a sixth feature representation, and the sixth feature representation being generated at the third stage. For example, the fourth stage corresponds to a resolution of 1024, the first stage corresponds to a resolution of 512, the second stage corresponds to a resolution of 256, the third stage corresponds to a resolution of 512, and the fifth stage corresponds to a resolution of 1024. In practical applications, the number of stages may be increased or decreased according to actual requirements, which will not be described in detail here.

The diffusion model is divided into multiple stages, which follows a denoising process of high resolution-low resolution-high resolution. High-resolution denoising is performed in a start stage and a final stage, and low-resolution denoising is performed in an intermediate stage. In this way, the calculation overhead may be reduced by a low-resolution prior, and the fidelity of the output of the network model may be ensured while improving the content generation efficiency. In addition, to reduce problems such as aliasing and blurring artifacts in the output of the network model, the resolution transition point is further optimized, and the denoising operation steps are adjusted adaptively in each stage.

### Example Apparatus and Device

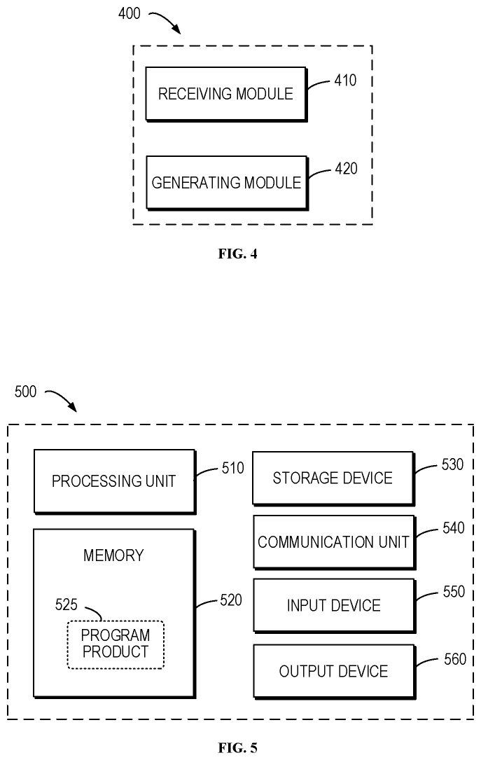

The embodiments of the present disclosure further provide a corresponding apparatus for implementing the foregoing method or process. FIG. 4 illustrates a schematic structural block diagram of an apparatus 400 for generating media content according to some embodiments of the present disclosure. The apparatus 400 may be implemented as or included in the electronic device 110 as discussed above. Each module/component in the apparatus 400 may be implemented by hardware, software, firmware, or any combination thereof.

As shown in FIG. 4, the apparatus 400 includes: a receiving module 410 configured to receive a media generation request associated with a diffusion model; and a generating module 420 configured to generate media content for the media generation request based on a denoising process of the diffusion model, the denoising process including at least a first stage, a second stage, and a third stage, the first stage being configured to perform at least one round of denoising on first noise data to determine a first feature representation, the second stage being configured to perform at least one round of denoising on second noise data to determine a second feature representation, the second noise data being constructed based on down-sampling the first feature representation, and the third stage being configured to perform at least one round of denoising on third noise data, the third noise data being constructed based on up-sampling the second feature representation.

In some embodiments, the generating module 420 includes: a down-sampling sub-module configured to determine a third feature representation by down-sampling the first feature representation; and a first noise addition sub-module configured to add first random noise to the third feature representation to construct the second noise data.

In some embodiments, the second stage corresponds to a first number of inference steps, and the first number is determined based on a first weight of the first random noise.

In some embodiments, the first number is positively correlated with the first weight.

In some embodiments, the generating module 420 is further configured to construct a first sampling scheduler corresponding to the second stage based on a first offset coefficient corresponding to the second stage; determine multiple denoising time steps corresponding to the first number of inference steps based on the first sampling scheduler; and perform at least one round of denoising on the second noise data based on the multiple denoising time steps.

In some embodiments, the generating module 420 further includes: an up-sampling sub-module configured to determine a fourth feature representation by up-sampling the second feature representation; and a second noise addition sub-module configured to add second random noise to the fourth feature representation to construct the third noise data.

In some embodiments, the third stage corresponds to a second number of inference steps, and the second number is determined based on a second weight of the second random noise.

In some embodiments, the second number is positively correlated with the second weight.

In some embodiments, the generating module 420 is further configured to construct a second sampling scheduler corresponding to the third stage based on a second offset coefficient corresponding to the third stage; determine multiple denoising time steps corresponding to the second number of inference steps based on the second sampling scheduler; and perform at least one round of denoising on the third noise data based on the multiple denoising time steps.

In some embodiments, the generating module 420 is further configured to perform at least one round of denoising on fourth noise data to determine a fifth feature representation, the fourth noise data being constructed based on down-sampling the first feature representation; and perform at least one round of denoising on fifth noise data to determine a sixth feature representation, the fifth noise data being constructed based on up-sampling the second feature representation.

The units included in the apparatus 400 may be implemented in various ways, including software, hardware, firmware, or any combination thereof. In some embodiments, one or more units may be implemented using software and/or firmware, for example machine-executable instructions stored on a storage medium. In addition to machine-executable instructions or as an alternative, some or all units in the apparatus 400 may be implemented at least partially by one or more hardware logic components. As an example, rather than a limitation, example types of hardware logic components that may be used include a field programmable gate array (FPGA), an application specific integrated circuit (ASIC), an application specific standard (ASSP), a system on chip (SOC), a complex programmable logic device (CPLD), and so on.

FIG. 5 is a block diagram of an electronic device 500 in which one or more embodiments of the present disclosure may be implemented. It should be understood that the electronic device 500 shown in FIG. 5 is only illustrative and should not constitute any limitation on the functions and scope of the embodiments described herein. The electronic device 500 shown in FIG. 5 may be used to implement the electronic device 110 shown in FIG. 1.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may perform various processing based on the programs stored in the memory 520. In a multi-processor system, multiple processing units execute computer executable instructions in parallel to improve the parallel processing capability of the electronic device 500.

The electronic device 500 typically includes multiple computer storage medium. Such medium may be any available medium that is accessible to the electronic device 500, including, but not limited to, volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store information and/or data (such as training data for training) and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or actions of the various embodiments of the present disclosure.

The communication unit 540 enables communication with other electronic devices via the communication medium. In addition, the functions of the components of the electronic device 500 may be implemented by a single computing cluster or multiple computing machines, which may communicate via communication connections. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) as needed via the communication unit 540, such as a storage device, a display device, etc., communicate with one or more devices that enable the user to interact with the electronic device 500, or communicate with any devices (such as a network card, a modem, etc.) that enable the electronic device 500 to communicate with one or more other electronic devices. Such communication may be performed via input/output (I/O) interfaces (not shown).

According to an example implementation of the present disclosure, a computer-readable storage medium is provided, which has computer-executable instructions stored thereon, where the computer-executable instructions are executed by a processor to implement the method described above. According to an example implementation of the present disclosure, there is further provided a computer program product, which is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, create an apparatus for implementing the functions/acts specified in one or more blocks of the flowcharts and/or block diagrams. These computer-readable program instructions may also be stored in a computer-readable storage medium, and the instructions cause a computer, a programmable data processing apparatus, and/or other devices to work in a specific manner, such that the computer-readable medium storing the instructions includes a manufactured product, which includes instructions for implementing various aspects of the functions/acts specified in one or more blocks of the flowcharts and/or block diagrams.

The computer-readable program instructions may be loaded onto a computer, another programmable data processing apparatus, or another device, such that a series of operations and steps are performed on the computer, the other programmable data processing apparatus, or the other device, to produce a computer-implemented process, such that the instructions executed on the computer, the other programmable data processing apparatus, or the other device implement the functions/acts specified in one or more blocks of the flowcharts and/or block diagrams.

The flowcharts and block diagrams in the drawings show the possibly implemented architectures, functions, and operations of the system, the method, and the computer program product according to multiple implementations of the present disclosure. In this regard, each block in the flowchart or block diagram may represent a module, a program segment, or a part of instructions, and the module, the program segment, or the part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform the specified functions or acts, or may be implemented by a combination of special-purpose hardware and computer instructions.

The implementations of the present disclosure have been described above, and the foregoing descriptions are illustrative, non-exhaustive, and are not limited to the disclosed implementations. Many modifications and variations will be apparent to those of ordinary skill in the art without departing from the scope of the described implementations. The terms used herein are chosen to best explain the principles of the implementations, the practical applications, or improvements to the technologies in the market, or to enable other ordinary skilled persons in the art to understand the implementations disclosed herein.

1. A method of generating media content, comprising:
receiving a media generation request associated with a diffusion model; and
generating media content for the media generation request based on a denoising process of the diffusion model, the denoising process comprising at least a first stage, a second stage, and a third stage;
the first stage being configured to perform at least one round of denoising on first noise data to determine a first feature representation;
the second stage being configured to perform at least one round of denoising on second noise data to determine a second feature representation, the second noise data being constructed based on down-sampling the first feature representation;
the third stage being configured to perform at least one round of denoising on third noise data, the third noise data being constructed based on up-sampling the second feature representation.

2. The method of claim 1, further comprising:
determining a third feature representation by down-sampling the first feature representation; and
adding first random noise to the third feature representation to construct the second noise data.

3. The method of claim 2, wherein the second stage corresponds to a first number of inference steps, and the first number is determined based on a first weight of the first random noise.

4. The method of claim 3, wherein the first number is positively correlated with the first weight.

5. The method of claim 3, wherein performing at least one round of denoising on the second noise data comprises:
constructing a first sampling scheduler corresponding to the second stage based on a first offset coefficient corresponding to the second stage;
determining a plurality of denoising time steps corresponding to the first number of inference steps based on the first sampling scheduler; and
performing at least one round of denoising on the second noise data based on the plurality of denoising time steps.

6. The method of claim 1, further comprising:
determining a fourth feature representation by up-sampling the second feature representation; and
adding second random noise to the fourth feature representation to construct the third noise data.

7. The method of claim 6, wherein the third stage corresponds to a second number of inference steps, and the second number is determined based on a second weight of the second random noise.

8. The method of claim 7, wherein the second number is positively correlated with the second weight.

9. The method of claim 7, wherein performing at least one round of denoising on the third noise data comprises:
constructing a second sampling scheduler corresponding to the third stage based on a second offset coefficient corresponding to the third stage;
determining a plurality of denoising time steps corresponding to the second number of inference steps based on the second sampling scheduler; and
performing at least one round of denoising on the third noise data based on the plurality of denoising time steps.

10. The method of claim 1, wherein the denoising process further comprises a fourth stage and a fifth stage,
the fourth stage being configured to perform at least one round of denoising on fourth noise data to determine a fifth feature representation, the first noise data being constructed based on down-sampling the fifth feature representation; and
the fifth stage being configured to perform at least one round of denoising on fifth noise data to determine a sixth feature representation, the fifth noise data being constructed based on up-sampling the sixth feature representation, and the sixth feature representation being generated at the third stage.

11. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
receiving a media generation request associated with a diffusion model; and
generating media content for the media generation request based on a denoising process of the diffusion model, the denoising process comprising at least a first stage, a second stage, and a third stage;
the first stage being configured to perform at least one round of denoising on first noise data to determine a first feature representation;
the second stage being configured to perform at least one round of denoising on second noise data to determine a second feature representation, the second noise data being constructed based on down-sampling the first feature representation;
the third stage being configured to perform at least one round of denoising on third noise data, the third noise data being constructed based on up-sampling the second feature representation.

12. A non-transitory computer-readable storage medium having a computer program stored thereon, the computer program, when executed by a processor, implementing acts comprising:
receiving a media generation request associated with a diffusion model; and
generating media content for the media generation request based on a denoising process of the diffusion model, the denoising process comprising at least a first stage, a second stage, and a third stage;
the first stage being configured to perform at least one round of denoising on first noise data to determine a first feature representation;
the second stage being configured to perform at least one round of denoising on second noise data to determine a second feature representation, the second noise data being constructed based on down-sampling the first feature representation;
the third stage being configured to perform at least one round of denoising on third noise data, the third noise data being constructed based on up-sampling the second feature representation.

13. The non-transitory computer-readable storage medium of claim 12, wherein the acts further comprise:
determining a third feature representation by down-sampling the first feature representation; and
adding first random noise to the third feature representation to construct the second noise data.

14. The non-transitory computer-readable storage medium of claim 13, wherein the second stage corresponds to a first number of inference steps, and the first number is determined based on a first weight of the first random noise.

15. The non-transitory computer-readable storage medium of claim 14, wherein the first number is positively correlated with the first weight.

16. The non-transitory computer-readable storage medium of claim 14, wherein performing at least one round of denoising on the second noise data comprises:
constructing a first sampling scheduler corresponding to the second stage based on a first offset coefficient corresponding to the second stage;
determining a plurality of denoising time steps corresponding to the first number of inference steps based on the first sampling scheduler; and
performing at least one round of denoising on the second noise data based on the plurality of denoising time steps.

17. The non-transitory computer-readable storage medium of claim 12, wherein the acts further comprise:
determining a fourth feature representation by up-sampling the second feature representation; and
adding second random noise to the fourth feature representation to construct the third noise data.

18. The non-transitory computer-readable storage medium of claim 17, wherein the third stage corresponds to a second number of inference steps, and the second number is determined based on a second weight of the second random noise.

19. The non-transitory computer-readable storage medium of claim 18, wherein the second number is positively correlated with the second weight.

20. The non-transitory computer-readable storage medium of claim 18, wherein performing at least one round of denoising on the third noise data comprises:
constructing a second sampling scheduler corresponding to the third stage based on a second offset coefficient corresponding to the third stage;
determining a plurality of denoising time steps corresponding to the second number of inference steps based on the second sampling scheduler; and
performing at least one round of denoising on the third noise data based on the plurality of denoising time steps.
